(19) United States
(12) Patent Application Publication
(10) Pub. No.: US 2024/0212042 A1
(43) Pub. Date: Jun. 27, 2024

(54) Front Fee Swapping

(71) Applicant: SafeMoon US, LLC, Pleasant Grove, UT (US)

(72) Inventor: Adel ElMessiry, Brentwood, TN (US)

(21) Appl. No.: 18/393,171

(22) Filed: Dec. 21, 2023

Related U.S. Application Data
(60) Provisional application No. 63/434,329, filed on Dec. 21, 2022.

(51) Int. Cl. G06Q 40/04

(52) U.S. Cl. CPC G06Q 40/04

(57) ABSTRACT

A method of calculating and charging swapping fees in a DEX token exchange, wherein a trader is provided with fee and outcome valuations in advance and the swapping fee is charged prior to or concurrently with the token exchange.

### CROSS REFERENCE TO RELATED APPLICATIONS

This patent application claims priority to U.S. provisional patent application 63/434,329, filed Dec. 21, 2022.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

### Field of the Invention

The invention is a method of calculating and charging swapping fees in a DEX exchange.

### Background of the Invention

Decentralized exchanges (DEXs) reported more than $1 trillion in trading volumes in the year 2021, according to The Block Research. That figure is a massive 858% increase compared to 2020 DEX trading volumes, based on data as of December 23. Last year, DEXs facilitated over $115 billion in trading volumes, the full report is at https://www.theblock.co/linked/128500/decentralized-exchanges-saw-over-1-trillion-in-trading-volume-this-year.

DEXs are “decentralized” in that they use self-executing smart contracts and thus do not require an intermediary. Trading on a DEX typically requires parties to each transaction to pay fees. One such fee is a “DEX fee”, which is usually a nominal fee charged by the DEX per transaction to help maintain the platform and develop new features. Next, a “swapping fee” or “rollover fee” is often charged for the service provided in unraveling tokens to be traded, generally representing the interest rate differential between the two currencies being traded when a position is held open overnight. Finally, DEX transactions require payment of a “gas fee”, which is a blockchain transaction fee paid to network validators/miners for their services to the blockchain as an incentive to stake their assets and help secure the network. For the purposes of this application, we will refer to the group of fees together as a “swapping fee”.

The main return generated by a DEX is driven by the swapping fees, which is a direct function in the ability of the exchange to support every increasingly complex token.

Transactions can be mainly described, but not limited to: transfer, buy or sell. The transfer transaction is when a token is sent from one wallet to another. The buy transaction is when the desired token is acquired by swapping another token for it on the DEX. The sell transaction is when the desired token is traded by swapping another token for it on the DEX.

Swapping one token with another depends on a liquidity pool consisting of certain amounts of both tokens. The liquidity pool is created by depositing equal value of both tokens in the liquidity pool smart contract. In return, a new token representing the supplied liquidity is created by the smart contract.

The current state of the art is to charge the swapping fees in the liquidity pool token, which leaves the DEX open to several adverse conditions such as, but not limited to: impermanent loss, excessive gas fees, and loss of revenue.

The introduction of sophisticated bots coupled with market volatility creates challenges for the current state of the art to handle the fees, which affects negatively both the tokens and the DEX.

The challenges addressed in this invention is focused on, but not limited to, allowing the swapping fees to be charged in advance of the token transaction on the DEX and utilizing the chain native token, thereby eliminating uncertainty by providing traders with a specific fee amount, payable prior to the execution of the trade transaction, and improving the swapped tokens' tokenomics.

### BRIEF SUMMARY OF THE INVENTION

In a preferred embodiment, a method of calculating and charging swapping fees in a DEX token exchange, wherein a trader is provided with fee and outcome valuations in advance and the swapping fee is charged prior to or concurrently with the token exchange, resulting in:
a. The ability to charge the DEX swapping fees in the chain native token.
b. The ability to charge the DEX swapping fees upfront.
c. The ability to distribute the DEX swapping fees in the chain native token.
d. the ability to reduce high-frequency trading attacks.
e. The ability to swap the full amount of the token.
f. The ability to eliminate the need to liquidate the DEX swapping fees.
g. The ability to improve the swapped tokens' tokenomics.

In another preferred embodiment, a method of calculating and charging swapping fees in a DEX token exchange, comprising the steps, in the order shown, in either FIG. 2 or FIG. 3.

A method of calculating and charging swapping fees in a DEX token exchange, comprising the steps of:
a. Computing the outcome value of Token B from a liquidity pool for Tokens A and B;
b. Computing the outcome value of Token B from a liquidity pool for Token B and a native token for the DEX;
c. Computing a swapping fee value and DEX fee value in native tokens and charging such fees to the trader; and
d. Swapping Token A for Token B.

In another preferred embodiment, the method of as described herein, wherein the outcome and/or fees computations are shared with the trader prior step d, and the trader is required to approve the swap before the fees are charged and the swap is executed.

A method of calculating and charging swapping fees in a DEX token exchange, comprising the steps of:
a. Computing the outcome value of Token B from a liquidity pool for Tokens A and B;
b. Determining that no liquidity pool between Token B and the native token exists;
c. Computing the outcome value of Token B from a liquidity pool for Token B and a native token for the DEX by using the known value of Token A;
d. Computing a swapping fee value and DEX fee value in native tokens and charging such fees to the trader; and
e. Swapping Token A for Token B.

### BRIEF DESCRIPTION OF THE DRAWINGS

FIG. 1 is a flow chart showing a typical swap token A to token B transaction.

FIG. 2 is a flow chart showing a potential embodiment of the proposed fee swap system.

FIG. 3 is a flow chart showing an alternate potential embodiment of the proposed fee swap system.

### DETAILED DESCRIPTION OF THE INVENTION

In a first exemplary embodiment, the value of the transaction is assessed by finding the value of the token to be swapped. The DEX would then compute the swapping fees utilizing the chain native token. The entire swapping fees alongside the chain transaction fees are then charged in advance of conducting the transaction.

In another exemplary embodiment, the value of the transaction is assessed by finding the value of the token to be swapped into. This is accomplished by finding the equivalent of the swapped token. The DEX would then compute the swapping fees utilizing the chain native token. The entire swapping fees alongside the chain transaction fees are then charged in advance of conducting the transaction.

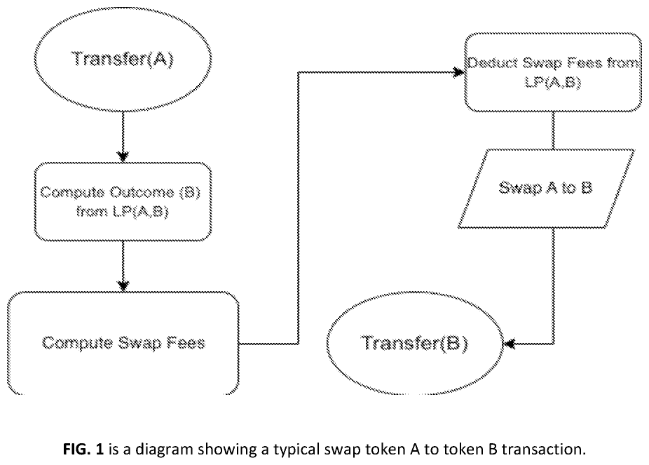

As depicted in FIG. 1, a typical swap transaction deducted the swapping fees from the actual liquidity pool which allows the transaction to take place.

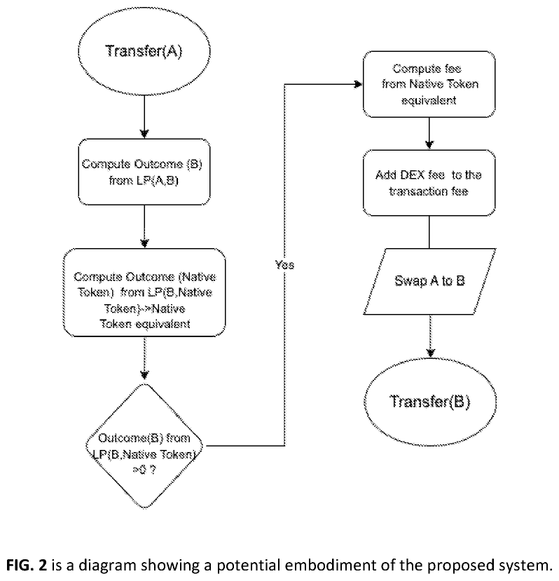

FIG. 2 depicts one way of implementing the embodiment, in which the value of the transaction is assessed by finding the value of the Token B to be bought with the trade-in of the trader's Token A. The DEX then computes the swapping fees by ascertaining the market value of Token B at the time of the trade and the value of the specific amount of Token B to be purchased, then multiplying the set fee percentages by the value of the purchased Token B, with such value then assigned to and paid in the chain native token.

Importantly, the calculations of both the swapping fee to be paid and the amount of Token B to be purchased are made and reported to the trader in advance of execution of the smart contract and completion of the trade. The trader, with full knowledge of the fees and outcome of the transaction, will then decide whether to execute the trade. Upon execution, the entire swapping fee will be charged, the tokens swapped and the trader will then own Token B of a value equivalent to that of the Token A traded, less the swapping fees.

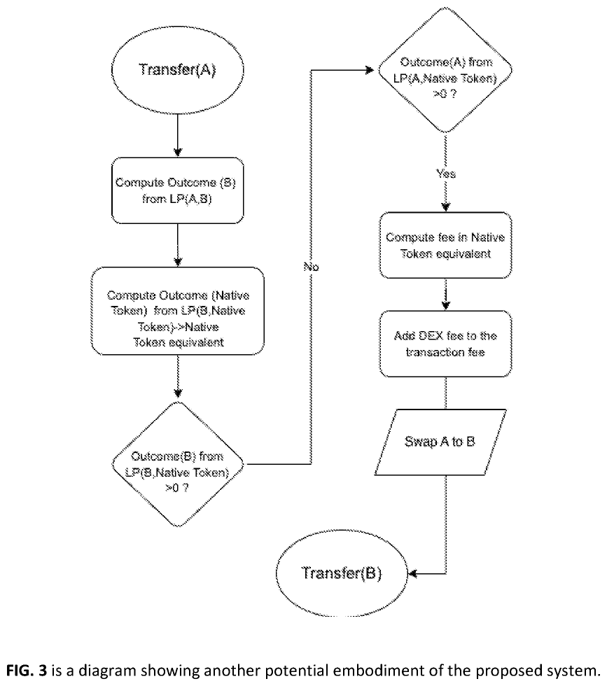

As depicted in FIG. 3, a different implementation of the embodiment utilizes the value of the swapped token. As in the iteration of FIG. 2, the amount of swapping fees to be paid and the outcome of the transaction in Token B will be calculated and reported to the trader in advance. In this iteration, however, the value of Token B prior to the trade cannot be ascertained due to the lack of a liquidity pool between Token B and the native token. Thus, the value of the transaction is first assessed by finding the value of Token B by finding the equivalent of the swapped Token A, allowing for an approximation of Token B's value. The DEX would then compute the swapping fees utilizing the chain native token, based on the Token A value. The entire swapping fees alongside the chain transaction fees are then reported and charged in advance of conducting the transaction.

### DETAILED DESCRIPTION OF THE FIGURES

Embodiments of the present invention are better understood from the following detailed description with reference to the following drawings:

FIG. 1 is a diagram showing a typical swap token A to token B transaction.

FIG. 2 is a diagram showing a potential embodiment of the proposed system, wherein the valuation of Token B can be ascertained, and thus the fee amount is determined based on the Token B value.

FIG. 3 is a diagram showing another potential embodiment of the proposed system, wherein the valuation of Token B cannot be ascertained at the time of the proposed trade, and thus the fee amount is determined based on the Token A value.

Unless indicated otherwise, identical reference numbers in the figures identify identical components with the same function. The terms drive unit and drive are used interchangeably herein.

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

I claim:

1. A method of calculating and charging swapping fees in a DEX token exchange, comprising the steps of:
a. Computing the outcome value of Token B from a liquidity pool for Tokens A and B;
b. Computing the outcome value of Token B from a liquidity pool for Token B and a native token for the DEX;
c. Computing a swapping fee value and DEX fee value in native tokens and charging such fees to the trader; and
d. Swapping Token A for Token B.

2. The method of claim 1, wherein the outcome and/or fees computations are shared with the trader prior step d, and the trader is required to approve the swap before the fees are charged and the swap is executed.

3. A method of calculating and charging swapping fees in a DEX token exchange, comprising the steps of:
a. Computing the outcome value of Token B from a liquidity pool for Tokens A and B;
b. Determining that no liquidity pool between Token B and the native token exists;
c. Computing the outcome value of Token B from a liquidity pool for Token B and a native token for the DEX by using the known value of Token A;
d. Computing a swapping fee value and DEX fee value in native tokens and charging such fees to the trader; and
e. Swapping Token A for Token B.
